(19) United States
(12) Patent Application Publication
(10) Pub. No.: US 2002/0031342 A1
(43) Pub. Date: Mar. 14, 2002

(54) Instant printer

(75) Inventor: Hidemi Sasaki, Saitama (JP)

Correspondence Address: SUGHRUE, MION, ZINN, MACPEAK & SEAS, 2100 Pennsylvania Avenue, N.W., Washington, DC, 20037, US

(73) Assignee: FUJI PHOTO FILM CO., LTD.

(21) Appl. No.: 09/949,678

(22) Filed: Sep. 12, 2001

(30) Foreign Application Priority Data
Sep. 12, 2000 (JP) 2000-275902

(51) Int. Cl. G03B 17/50

(52) U.S. Cl. 396/30; 396/31

(57) ABSTRACT

A digital still camera has a print head for projecting printing light beams onto a mono-sheet type instant film. The instant films are stacked in a film pack which is loaded in the digital still camera. Since a processing fluid pod on the leading end of the instant film is thicker than a trap portion on the trailing end of the instant film, the rear surface of the film pack is inclined to fit the shape of stacked instant films. An LCD unit is incorporated in a pack loading door of the digital still camera. The LCD unit is inclined to fit the inclined rear surface of the film pack, so a vacant space between the film pack and the camera body may be decreased.

### BACKGROUND OF THE INVENTION

1. Field of the Invention

The present invention relates to an instant printer for recording an image onto a mono-sheet type instant film which is contained in a film pack. More specifically, the present invention relates to the instant printer with an imaging device in which the film pack and the imaging device are properly positioned to thin a thickness of the instant printer.

2. Background Arts

A digital still camera with an instant printer is well-known. The digital still camera has an imaging section for converting an optical subject image into electric image signals by use of a CCD image sensor, and a printer section for recording an image based on image data obtained by digital data conversion from the image signals. By use of such digital still camera, a hard copy of the subject image may be obtained at the place where photography is carried out. A mono-sheet type instant film is used as a recording medium. The printer section includes a print head for projecting printing light beams to the instant film while moving in a direction parallel to a recording surface of the instant film.

The instant film includes a photosensitive sheet, an image receiving sheet, a developing solution pod and a trap portion. The developing solution pod, which is provided on one end portion of the instant film, contains a developing solution which is spread between the photosensitive sheet and the image receiving sheet. A surplus of the developing solution after development is accepted by the trap portion which is disposed on the other end portion of the instant film. About ten sheets of the instant films are stacked in a plastic film pack which has a rectangular-shaped exposure opening in a front surface. The instant films in the film pack are arranged in a same orientation direction. Since the developing solution pod is thicker than the trap portion, a rear surface of the film pack is inclined toward the trap portion so as to fit the inclination of the stacked instant films.

As a conventional instant camera, the digital still camera with the instant printer has a pack loading chamber for containing the film pack. The pack loading chamber is usually covered with a pack loading door, which is open in exchanging the film pack.

The digital still camera having the above structure needs a space for containing an imaging section which includes the CCD image sensor, a taking lens, a liquid crystal display (LCD) unit for displaying an image photographed by the CCD image sensor. Moreover, the digital still camera needs a space for storing the print head, a head moving mechanism and the pack loading chamber, and a space for moving the print head. Thus, the digital still camera with the printer section becomes larger than the conventional one which has no printer section.

Especially, the print head is positioned so as to confront with the exposure opening of the film pack, which makes the camera body thicker. On the other hand, there is a vacant space between the pack loading door and the inclined rear surface of the film pack, especially near the trap portion. In order to thin the digital still camera, it is necessary to make use of such vacant space.

### SUMMARY OF THE INVENTION

In view of the foregoing, an object of the present invention is to provide a thin instant printer for recording the image obtained by an imaging operation to an instant film.

To achieve the above objects, the instant printer is loaded with a film pack which contains plural stacked instant films, and has a display unit for displaying the image which is located at a position to face a trailing end portion of a rear side of the film pack. The instant film has a processing fluid pod on a leading end and a trap portion for accepting surplus of the processing fluid on a trailing end. The rear side of the film pack is up and down according to difference in height of stacked instant films between a leading end and a trailing end.

In the preferred embodiment, the rear side of the film pack is inclined such that the film pack becomes thin gradually toward the trailing end portion from the leading end portion. As the display unit, it is possible to apply an LCD unit which includes an LCD panel, a light source and a reflection plate. One end portion of the LCD unit may be thicker than the other end portion thereof by inclining the reflection plate against the LCD panel. The LCD unit may be located at a position where one end portion of the LCD unit faces the trailing end portion of the film pack.

The instant printer has a pack loading door, which is opened and closed in loading the film pack. The LCD unit is incorporated in the pack loading door. Instead of the LCD unit, an imaging unit for photographing a subject may be located at a position to face a trailing end portion of a rear side of the film pack. By disposing the LCD unit or the imaging unit in a vacant space between the film pack and a housing of the printer, it is possible to make the instant printer thinner.

### BRIEF DESCRIPTION OF THE DRAWINGS

The above and other objects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is a front perspective view of the first embodiment of a digital still camera with an instant printer of the present invention;

FIG. 2 is a rear perspective view of the digital still camera of FIG. 1;

FIG. 3 is a perspective view of a film pack having plural instant films;

FIG. 4 is a cross section of the digital still camera;

FIG. 5 is a block diagram showing a circuitry of the digital still camera;

FIG. 6 is a front perspective view of the second embodiment of the digital still camera with the instant printer of the present invention;

FIG. 7 is a rear perspective view of the digital still camera of FIG. 6; and

FIG. 8 is a cross section of the digital still camera of FIG. 6.

### DETAILED DESCRIPTION OF THE EMBODIMENT

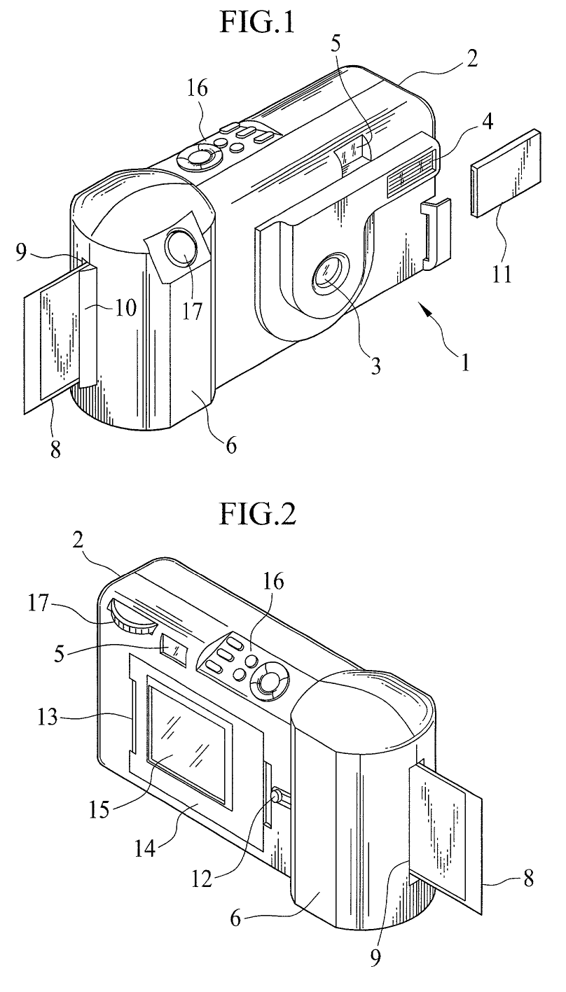

As shown in FIGS. 1, 2, a digital still camera 1 of the first embodiment includes an imaging section and a printer section which are contained in a camera body 2. A taking lens 3 and a flash projector 4 are appeared in a front side of the camera body 2. An optical viewfinder 5 is provided above the taking lens 3. A photography button 7 is provided in a grip portion 6. The grip portion 6 has a film ejection slot 9 and a slot cover 10 for ejecting a mono-sheet type instant film 8. The grip portion 6 also has a buttery chamber, in which four AA dry batteries are connected in series. In a lateral side of the camera body 2 are provided an input/output terminals for connecting and exchanging image data with an external device like a computer, and a connector slot for inserting an attachable memory card 11.

A pack loading door 14 is attached on a rear side of the digital still camera 1. The pack loading door 13 is rotatable around a hinge portion 13, and is open by operating a release knob 12. The pack loading door 14 includes a liquid crystal display (LCD) unit 15 which displays subject images photographed through the taking lens 3 in a real-time fashion and a full-color subject image reproduced based on image data stored in a memory. Above the pack loading door 13 is provided a console panel 16 and a mode changeover dial 17. The console panel 16 has various operation buttons, such as a print start button, manual focusing button and a manual exposure correction button. By operating the changeover dial 17, the operation mode of the digital still camera 1 may be changed between a taking mode and a reproduction mode.

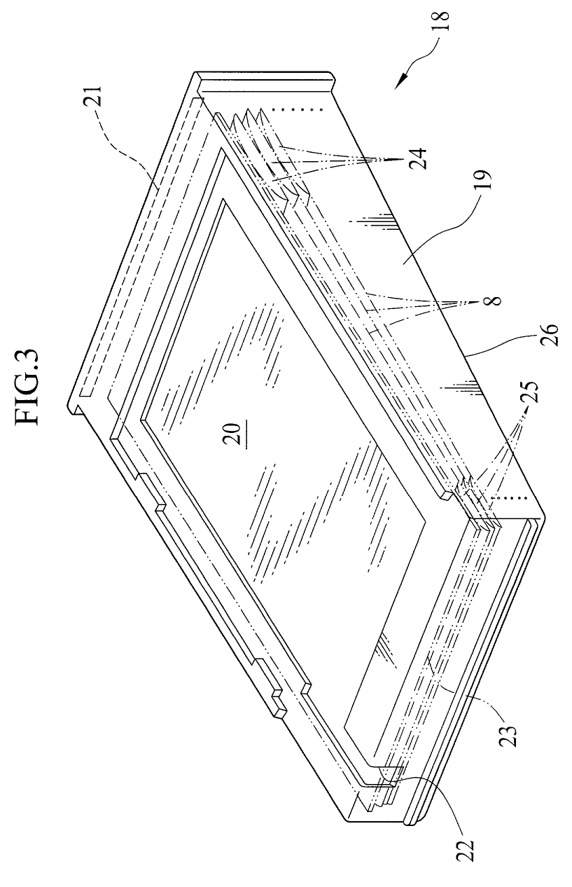

As shown in FIG. 3, a plurality of instant films 8 are stacked in a film pack 18 in the same orientation direction. The film pack 18 may be loaded in the digital still camera 1 by opening the pack loading door 13. The film pack 18 has a box-shaped case body 19, an exposure opening 20 and a cutout 22. The exposure opening 20 has a rectangular shape, and is formed through a top side of the case body 19. The cutout 22 is connected with the exposure opening 20. After exposure, a well-known claw member goes into the film pack 18 through the cutout 22. A light-shielding member 23 is provided on the uppermost instant film 8 for shielding unused instant films 8 from ambient light.

The instant film 8 is the same as the ordinary one, and has a photosensitive sheet, a image transfer sheet, a developing solution pod 24 and a trap portion 25. The developing solution pod 24 contains a developing solution which is spread between the photosensitive sheet and the image transfer sheet during development process. After the developing solution is completely spread, the trap portion 25 accepts the surplus of the developing solution. Since the trap portion 25 only accepts the surplus of the developing solution which is contained in the developing solution pod 24, a thickness of the developing solution pod 24 is larger than that of the trap portion 25. Thus, the stacked instant films 8 in the developing solution pod side is thicker than the trap portion side thereof, which causes a inclination of the stacked instant films 8. The rear side of the film pack 18 has an inclined surface 26 such that the film pack 18 becomes thin gradually toward a trailing end portion (trap portion side) from a leading end portion (developing solution pod side).

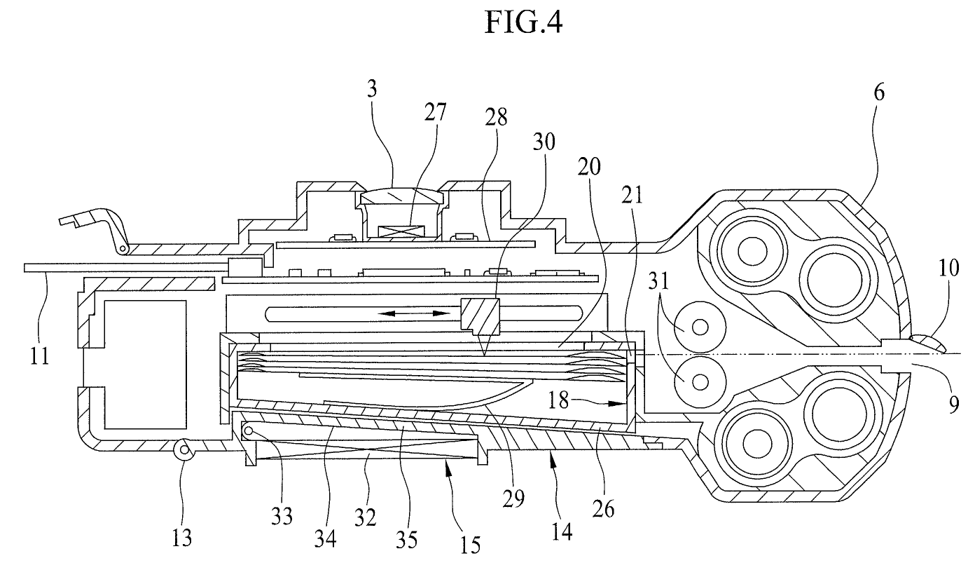

As shown in FIG. 4, an imaging unit, which is comprised of the taking lens 3, a CCD image sensor 27 and an imaging circuit 28, is disposed in a front side of the digital still camera 1. The CCD image sensor 27 is located behind the taking lens 3. The film pack 18 is loaded in a pack loading chamber through the pack loading door 14, and has a spring plate 29 to press the instant films 8 toward the exposure opening 20. The pack loading door 14 may have a pair of pressing members as disclosed in JP-A 11-301027, which pushes the instant films through a pair of openings formed in the rear side of the film pack. In that case, it is possible to omit the spring plate.

A print head 30 is confronted with the exposure opening 20 and is movable in a sub-scan direction shown by the arrow. The print head 30 projects printing light beams which is extended in a main-scan direction perpendicular to the sub-scan direction. An image is recorded on an exposure surface of the instant film 8 by projecting printing light beams from the print head 30 while the print head is moved in the sub-scan direction. As disclosed in JP-A 11-249239, the print head 30 may project red, green and blue printing light beams to record a full-color image in a three-color frame sequential manner.

The digital still camera 1 has a claw mechanism (not shown) for thrusting the uppermost instant film 8 out of the film pack 18. The claw mechanism has the same structure as that provided in a conventional instant camera, which is disclosed in JP-A 4-194832. The instant film 8 is pushed to a spread roller pairs 31, by which a development and ejection of the instant film 8 are carried out.

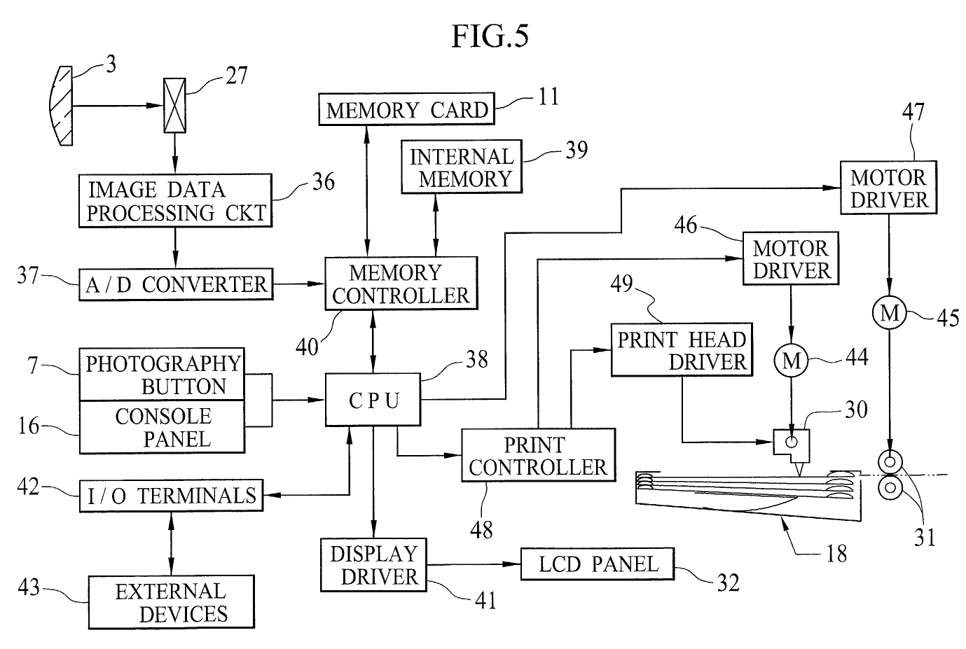

The LCD unit 15 is located at a position to face the trailing end side (trap portion side) of the inclined surface 26 of the film pack 18. The LCD unit 15, used as a monitor of side-lightening type, has an LCD panel 32, a light source 33 and a reflection plate 34. The LCD panel 32 has a liquid crystal array in which plural liquid crystal segments are arranged in a matrix, and color filters which are overlapped with respective liquid crystal segments. The light source 33 projects back light for lightening the LCD panel 32 from behind. The back light from the light source 33 is reflected by the reflection plate 34 toward the rear side of the LCD panel 32. The LCD panel 15 is connected to one end terminals of a flexible print circuit substrate on which plural wiring patterns for controlling applied voltages to all segments are formed. The other end terminals of the flexible print circuit substrate is connected to a main circuit substrate with a CPU 38 (see FIG. 5) and so forth.

The reflection plate 34 is inclined against the LCD panel 32 such that a distance between the reflection plate 34 and the LCD panel 32 becomes smaller as a distance from the light source 33 becomes larger. Thus, light intensity of the back light becomes equal, regardless of the distance from the light source 33. Because of the inclination of the reflection plate 34, the LCD unit 15 has a roughly wedge shape. That is, one end of the LCD unit 15 (light source side) is thicker than the other end thereof. The wedge-shaped LCD unit 15 is positioned such that the light source side faces the trap portion side of the film pack 18. Since the inclination surface 26 of the film pack 18 fits the inclination surface of the LCD unit 15, the protrusions of the LCD unit 15 and the film pack 18 may be canceled.

FIG. 5 shows a block diagram of the circuitry of the digital still camera 1. An optical subject image is focused on a photosensitive surface of the CCD image sensor 27, and focusing and exposure correction are performed. On the photosensitive surface of the CCD image sensor 27, micro color filters of red, green and blue are arranged in a matrix. The optical subject image on the photosensitive surface is converted into electrical image signals of three color components in respective pixels. Image signals are sent to an image data processing circuit 36, in which various image processing is performed, such as white balance correction and gamma correction. The processed image signals are sent to an A/D converter 37 to obtain digitalized image data.

The CPU 38 controls the electrical operation of the digital still camera 1, including the above image data processing circuit 36 and a memory controller 40 for controlling the exchange of image data stored in an internal memory 39. Upon operating the photography button 7 and the console panel 16, an entered command is sent to the corresponding element in the digital still camera 1 by way of the CPU 38.

A display driver 41 is connected to the CPU 38, and controls output signals of respective segments of the LCD panel 32, by which images and characters are displayed in the LCD panel 32. An input/output (I/O) terminals 42 includes connectors for connecting kinds of cables for exchanging image data with external devices 43 like a computer, and a conversion circuit for converting image data into that which the external device 43 can store. Thereby, image data in the internal memory 39 and the memory card 11 may be exchanged with the external devices 43.

A first stepping motor 44 is connected with the print head 30. The stepping motor 44 moves the print head 30 in the sub-scan direction in accordance with drive pulses from a motor driver 46. A second stepping motor 45 is connected with the spread roller 41, and rotates the spread roller 41 in accordance with drive pulsed from a motor driver 47.

A print controller 48 is connected to the CPU 38 and the print head driver 49. When a print order signal is sent from the CPU 38, the print controller 48 reads image data in the memory card 11, the internal memory 39 and the external devices 43. Then, the print controller 48 sends image data to the print head driver 49. The print head driver 49 produces linear image data of respective colors, and sends it sequentially to the print head 30. Based on linear image data, the print head 30 projects the linear print light beam to the instant film 8. The image of one color is recorded by projecting linear print light beam while the print head 30 is moved in the sub-scan direction. The above process is carried out by three times changing the color of linear print beams, to record a full-color image in the instant film 8.

Next, the operation of the above digital still camera 1 will be described. First off, the mode changeover dial 17 is rotated from a “OFF” position, to turn on the digital still camera 1. At the same time, the operation mode of the digital still camera 1 is determined, depending upon a set position of the mode changeover dial 17. In the imaging mode, the light source 33 is turned on by operating the console panel 16, and a subject image focused on the CCD image sensor 27 is continuously displayed on the LCD panel 32. When the photography button 7 is depressed after framing of the subject, image data of the image displayed on the LCD panel 32 at that time is stored in the internal memory 39. In order to save the power of the battery, the optical viewfinder 5 may be used instead of the LCD panel 32.

When photography is repeated, a vacant capacity of the internal memory 39 is not enough to carry out more photography. In that case, the mode changeover dial 17 is operated to change the operation mode into the reproduction mode, in which the photographed image is displayed on the LCD panel 32 by keying the console panel 16. In the reproduction mode, image data of unnecessary images may be deleted. Moreover, image data may be transferred to the memory card 11 from the internal memory 39. Thereby, the vacant capacity of the internal memory 39 is expanded enough to perform more photography.

If necessary, the print start button in the console panel 16 may be operated in both operation mode, so that a print command is entered to the CPU 38. After selecting a designated image among those stored in the internal memory 39, the memory card 11 and the external devices 43, the print head 30 is driven to project the printing light beams. While the first stepping motor 44 is actuated to move the print head 30 in the sub-scan direction, an image of one color is exposed onto the uppermost instant film 8 line by line. In this way, the image of different colors are exposed on the instant film 8, to record the full-color image in a three-color frame sequential manner. When the exposure is completed, the well-known claw mechanism is actuated to feed the exposed instant film 8 toward the spread rollers 31. In addition, the second stepping motor 45 rotates the spread rollers 31. Thereby, the processing fluid pod 24 is ruptured to spread the processing fluid between the photosensitive sheet and the image transfer sheet.

Thereafter, the instant film 8 is conveyed toward the film ejection slot 9 by the spread rollers 31. The leading end of the instant film 8 pushes the slot cover 10 outward to open the film ejection slot 9. Thereby, the instant film 8 is ejected through the film ejection slot 9. In one or few minutes after ejection, a positive image is transferred to the image receiving surface of the instant film 8, to obtain a full-color print picture.

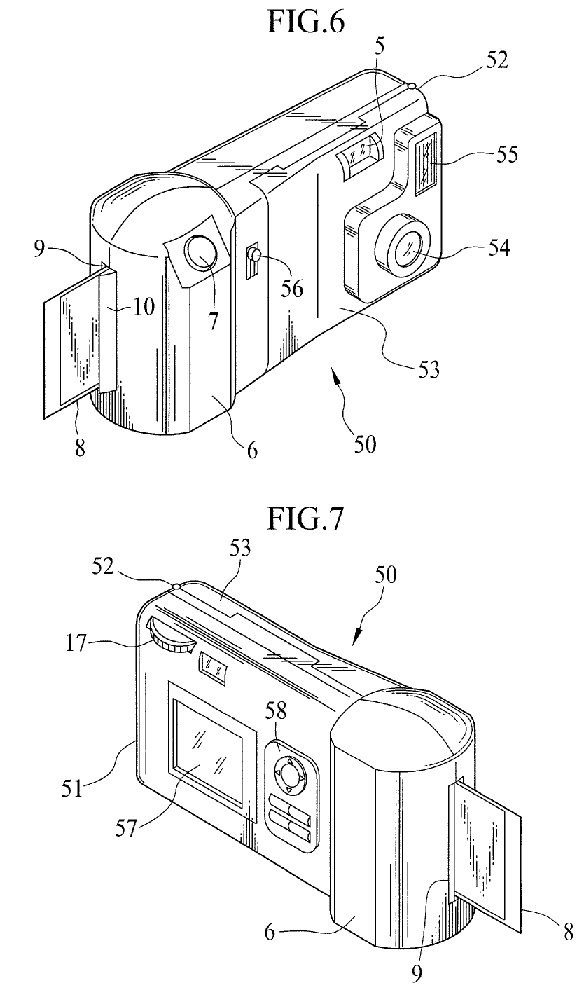

FIGS. 6, 7, 8 shows the second embodiment of the digital still camera of the present invention, in which an imaging unit is disposed so as to face the inclined surface 26 of the film pack 8. In the following descriptions, elements which are substantially equivalent to those used in the above embodiment are designated by the same reference numbers as in the above embodiment, so the description of these elements are omitted.

In a front side of a camera body 51 of the digital still camera 50, a pack loading door 53 is provided in a rotatable manner around a hinge portion 52. A taking lens 54 and a flash projector 55 are appeared in a hinge portion side of the pack loading door 53. By operating a release knob 56 on the front side of the camera body 51, the pack loading door 53 is released to open a pack loading chamber, in which the film pack 18 is loaded. On the rear side of the camera body 51, an LCD unit 67 and a console panel 58 are disposed.

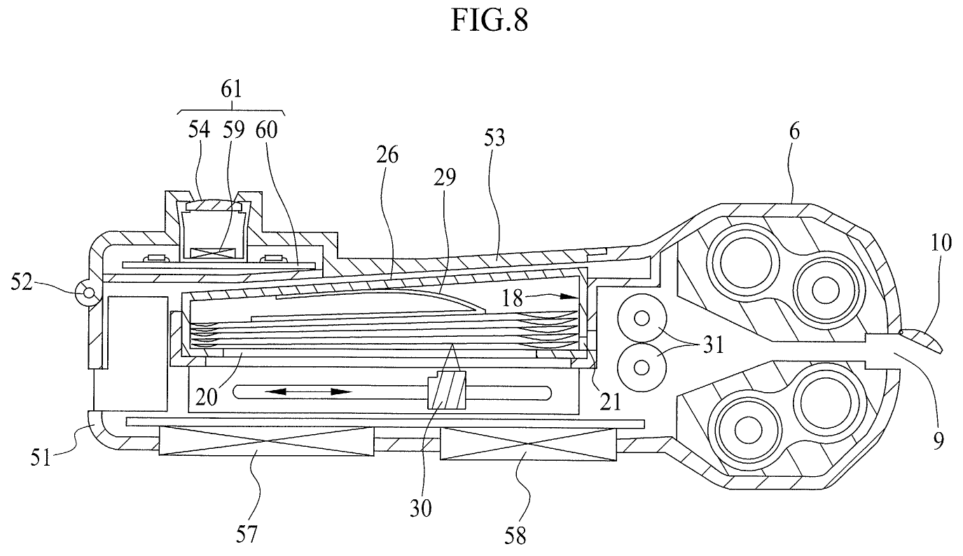

FIG. 8 shows a cross section of the digital camera 50. The pack loading door 53 contains an imaging unit 61 which is comprised of the taking lens 54, a CCD image sensor 59 and the imaging circuit 60. The CCD image sensor 59 is located behind the taking lens 54. Upon releasing the pack loading door 53, the imaging unit 61 is rotated together with the pack loading door 53. After loading the film pack 18, the pack loading door 53 is closed. Then, the imaging unit 61 faces the trap portion side of the inclined surface 26 of the film pack 18.

The imaging unit 61 and the flash projector 55 are firmly assembled in the pack loading door 53 so as not to be separated when the pack loading door 53 rotates. Also the imaging unit 61 is electrically connected to the main circuit board by way of a flexible print circuit substrate which is connected to the imaging circuit 60. The imaging unit 61 is located at a position to confront with the trap portion side of the inclined surface at the time when the pack loading door 53 is closed. Thus, it is possible to decrease the protrusion of imaging unit 61 by use of the vacant space between the camera body 51 and the film pack 18. The digital still camera 50 is the same circuitry as the first embodiment, so the description is omitted.

The instant printer of the present invention is not limited to the above two embodiments. For instance, the present invention is applicable to a single instant printer which do not have the imaging unit or the LCD unit. Any suitable instant printers are applicable if the printer uses a film pack with plural instant films. The rear side of the film pack 8 may have any suitable shapes other than the inclined surface. For instance, the rear surface of the film pack 8 may have different levels. Instead of positioning the imaging unit or the LCD unit, a memory card loading device or the console panel 16 may be positioned in a vacant space between the inclined surface 26 and the camera body.

In case of disposing the memory card loading device together with the LCD unit, the pack loading door may have an opening for inserting the memory card, a connector for connecting the electrical contact of the memory card, and a wiring circuit substrate for connecting the connector with a main circuit substrate of the digital still camera. In case of disposing the console panel together with the LCD unit, operation buttons may be located around the LCD unit.

Thus, the present invention is not to be limited to the above embodiments, but on the contrary, various modifications are possible to those skilled in the art without departing from the scope of claims appended hereto.

What is claimed is:

1. An instant printer for exposing an image onto an instant film, being loaded with a film pack which contains a plurality of stacked said instant films, a front side of said film pack having an exposure opening for exposing said instant film, and a rear side of said film pack being up and down in accordance with difference in height between a leading end of stacked said instant films and a trailing end of stacked said instant films, said instant printer comprising:
a display unit for displaying said image, said display unit being located at a position to face a trailing end portion of said rear side of said film pack.

2. An instant printer as defined in claim 1, wherein said instant film has a processing fluid pod on the leading end thereof and a trap portion for accepting surplus of said processing fluid on the trailing end thereof, said processing fluid being thicker than said trap portion.

3. An instant printer as defined in claim 2, wherein said rear side of said film pack is inclined such that said film pack becomes thin gradually toward said trailing end portion from said leading end portion.

4. An instant film as defined in claim 3, wherein said display unit is an LCD unit which includes an LCD panel, a light source and a reflection plate, one end portion of said LCD unit being thicker than the other end portion thereof by inclining said reflection plate against said LCD panel, said LCD unit being located at a position where said one end portion of said LCD unit faces said trailing end portion of said film pack.

5. An instant film as defined in claim 4, further comprising a pack loading door which is opened and closed in loading said film pack, said LCD unit being incorporated in said pack loading door.

6. An instant printer for exposing an image onto an instant film, being loaded with a film pack which contains a plurality of stacked said instant films, a front side of said film pack having an exposure opening for exposing said instant film, and a rear side of said film pack being up and down in accordance with difference in height between a leading end of stacked said instant films and a trailing end of stacked said instant films, said instant printer comprising:
an imaging unit for producing image data of said image by photographing a subject, said imaging unit being located at a position to face a trailing end portion of said rear side of said film pack.

7. An instant printer as defined in claim 6, wherein said instant film has a processing fluid pod on the leading end thereof and a trap portion for accepting surplus of said processing fluid on the trailing end thereof, said processing fluid being thicker than said trap portion.

8. An instant printer as defined in claim 7, wherein said rear side of said film pack is inclined such that said film pack becomes thin gradually toward said trailing end portion from said leading end portion.

9. An instant film as defined in claim 8, further comprising a pack loading door which is opened and closed in loading said film pack, said imaging unit being incorporated in said pack loading door.
